(19) United States
(12) Patent Application Publication
(10) Pub. No.: US 2023/0195492 A1
(43) Pub. Date: Jun. 22, 2023

(54) COMMUNICATION ENCRYPTION AND DECRYPTION ON DEVICES

(71) Applicant: INTERNATIONAL BUSINESS MACHINES CORPORATION, Armonk, NY (US)

(72) Inventors: Hubertus Franke, Cortlandt Manor, NY (US); Christoph Raisch, Gerlingen (DE); Marco Kraemer, Sindelfingen (DE); Bulent Abali, Tenafly, NJ (US)

(21) Appl. No.: 17/644,665

(22) Filed: Dec. 16, 2021

(51) Int. Cl. G06F 9/455; G06F 21/60; H04L 9/08; G06F 13/16; G06F 13/28

(52) U.S. Cl. CPC G06F 9/45558; G06F 21/606; H04L 9/0861; H04L 9/0819; H04L 9/0894; G06F 21/602; G06F 13/1668; G06F 13/28; G06F 2009/45579; G06F 2009/45587

(57) ABSTRACT

An apparatus, a method, and a computer program product are provided that provide confidential computing on virtual machines by securing input/output operations between a virtual machine and a device. The method includes establishing an input/output (I/O) device with an encryption key associated with a virtual machine and transmitting, by the I/O device, an I/O transaction requesting encrypted data stored in physical memory by the virtual machine. the I/O transaction includes a direct memory access (DMA) memory address and a bus device function. The method also includes retrieving, by an input/output memory management unit (IOMMU), the encrypted data mapped from the DMA memory address to a physical memory address in the physical memory and transmitting, by the IOMMU, the encrypted data to the I/O device. The method further includes decrypting, by the I/O device, the encrypted data using the encryption key associated with the virtual machine and processing the decrypted data.

### BACKGROUND

The present disclosure relates to virtualization, and more specifically, to confidential computing on virtual machines by utilizing a device to secure input/output operations between the device and a virtual machine.

Virtualization uses software to create an abstraction layer over computer hardware that allows the hardware elements of a single computer (e.g., processors, memory, storage, etc.) to be divided into multiple virtual computers, commonly called virtual machines. Each virtual machine can run its own operating system and can behave like an independent computer, even though it is running on just a portion of the actual underlying computer hardware.

Confidential computing refers to an initiative focused on ensuring data is secure while in use. Techniques are used to enable encrypted data to be processed in memory while lowering the risk of exposing it to other components or devices on the system. These efforts attempt to reduce the potential for sensitive data to be exposed while also offering a higher degree of control to the user.

### SUMMARY

Embodiments of the present disclosure include a method for confidential computing on virtual machines by utilizing a device to secure input/output operations between the device and a virtual machine. The method includes establishing an input/output (I/O) device with an encryption key associated with a virtual machine and transmitting, by the I/O device, an I/O transaction requesting encrypted data stored in physical memory by the virtual machine. The I/O transaction includes a direct memory access (DMA) memory address and a bus device function. The method also includes retrieving, by an input/output memory management unit (IOMMU), the encrypted data mapped from the DMA memory address to a physical memory address in the physical memory and transmitting, by the IOMMU, the encrypted data to the I/O device. The method further includes decrypting, by the I/O device, the encrypted data using the encryption key associated with the virtual machine and processing the decrypted data.

Additional embodiments of the present disclosure include a computer program product for confidential computing on virtual machines by utilizing a device to secure input/output operations between the device and a virtual machine, a computer-readable storage medium having a computer-readable program stored therein, wherein the computer-readable program when executed on a computing device, causes the computing device to establish an input/output (I/O) device with an encryption key associated with a virtual machine and transmit, by the I/O device, an I/O transaction requesting encrypted data stored in physical memory by the virtual machine. The I/O transaction includes a direct memory access (DMA) memory address and a bus device function. The computer program product also causes the computing device to retrieve, by an input/output memory management unit (IOMMU), the encrypted data mapped from the DMA memory address to a physical memory address in the physical memory and transmit, by the IOMMU, the encrypted data to the I/O device. The computer program product further causes the computing device to decrypt, by the I/O device, the encrypted data using the encryption key associated with the virtual machine and process the decrypted data.

Further embodiments of the present disclosure include an apparatus for confidential computing on virtual machines by utilizing a device to secure input/output operations between the device and a virtual machine. The apparatus includes a memory, a processor, local data storage having stored thereon computer-executable code. The computer-executable code includes the program instruction executable by a processor to cause the processor to perform the method described above. The present summary is not intended to illustrate each aspect of, every implementation of, and/or every embodiment of the present disclosure.

### BRIEF DESCRIPTION OF THE DRAWINGS

These and other features, aspects, and advantages of the embodiments of the disclosure will become better understood with regard to the following description, appended claims, and accompanying drawings where:

FIG. 1 is a block diagram illustrating an operation of the primary operational elements of a virtualization computing environment used by one or more embodiments of the present disclosure.

FIG. 2 is a flow diagram illustrating a process of providing confidential computing on virtual machines by securing input/output operations between a virtual machine and a device and performed in accordance with embodiments of the present disclosure.

FIG. 3 is a high-level block diagram illustrating an example computer system that may be used in implementing one or more of the methods, tools, and modules, and any related functions, described herein in which the disclosure may be implemented.

FIG. 4 depicts a cloud computing environment in accordance with embodiments of the present disclosure.

FIG. 5 depicts abstraction model layers in accordance with embodiments of the present disclosure.

While the present disclosure is amenable to various modifications and alternative forms, specifics thereof have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

The present disclosure relates to virtualization, and more specifically, to confidential computing on virtual machines by utilizing a device to secure input/output operations between the device and a virtual machine. While the present disclosure is not necessarily limited to such applications, various aspects of the disclosure may be appreciated through a discussion of various examples using this context.

A current trend in computing is the placement of data and enterprise workloads in the cloud by utilizing hosting services provided by cloud server providers (CSPs). As a result of the hosting of the data and enterprise workloads in the cloud, customers (e.g., guests) of the CSPs are requesting better security and isolation solutions for their workloads. In particular, customers seek solutions that enable the operation of CSP-provided software outside of a Trusted Computing Base (TCB) of the guest's software. The TCB of a system refers to a set of hardware, firmware, and/or software components that have the ability to influence the trust for the overall operation of the system. Accordingly, for example, a virtual machine monitor (VMM or hypervisor) establishes and controls a virtual machine (VM), which executes the guest software. Guests, therefore, want the components of the VMM to operate outside of the guest's TCB. If the VMM is executed as software on top of the hardware of a virtualized server, the VMM is considered untrusted software.

In furtherance of data security in CSP-based systems, various techniques have been employed to protect sensitive data residing in regions of memory, e.g., of CSP servers. Some system processors provide cryptographic mechanisms for encryption, integrity, and replay protection. Memory encryption protects the confidentiality of memory-resident data. For example, total memory encryption (TME) may encrypt data that is moving from a processor core to memory and may decrypt the encrypted data on its way back to the processor core. Additionally, the CSP server may support the use of multiple encryption keys, e.g., a different key for each secure domain serviced by the server, which could be dozens or thousands of domains. Accordingly, a TME engine may be adapted to securely manage the use of multiple encryption keys as a multi-key TME (or MK-TME) engine, which may be referred to more generally herein as a cryptographic engine.

Memory virtualization in a majority of architectures is realized through a duality of page tables. The host (e.g., CSP-based systems) treats the guest VM as an application that has an address space for which a page table provides the translation from the guest's physical address to the host's physical address. This is commonly referred to as a nested page table (nPT). The guest operating system provides a guest page table (gPT) for each of the applications it is running. A guest application with a guest virtual address (gVA) can first be translated through the gPT to obtain its guest physical address (gPA), which then can be translated to the nPT to the host physical address (hPA) that is presented to the memory controller.

Typically, an input-output memory management unit (IOMMU) is utilized to protect a host system from rogue devices. A rogue device can be a device or peripheral that attempts direct memory accesses (DMA) without authorization. The IOMMUs also handle input/output (I/O) operations where I/O operations are given addresses of I/O buffer addresses. When the addresses are presented on the bus, the address is translated by the IOMMU prior to being presented to the memory controller.

For encrypted memory, encryption keys are embedded into the memory controller and are managed either explicitly or implicitly by the hypervisor. Memory accesses in the memory controller are tagged by the hardware using an address-spaced identifier (ASID) of the currently executing context (e.g., the VM or the host), which can then be used as a selector for the encryption key. As such, the host does not have access to the guest virtual memory due to it not having direct access to the encryption key.

Limitations on confidential computing on a VM remain, however, as data has to be unencrypted for I/O operations to occur with a device. Devices include, but are not limited to, modems, network interface cards (NIC), sound cards, keyboards, mice, hard drives, flash drives, sound cards, other peripheral component interconnect (PCI) devices, and the like. When dealing with memory, a device must be able to read and write data as well as inspect packet headers to take appropriate routing actions. The data is required to be decrypted on a device DMA read operation or encrypted on a device DMA write operation. In order to facilitate the encryption and decryption operations for the devices, a bounce buffer is typically utilized that is accessible by both the guest and the host and encrypted using a host key. While memory can be encrypted on a per VM basis or per-host basis, I/O operations only have one translation layer using the bounce buffer. This limits devices, such as single-root I/O virtualization (SR-IOV) devices and prevents them from being fully utilized. The bounce buffer technique also does not provide support for passthrough devices.

SR-IOV capable devices can include logic to support the SR-IOV implementation on an I/O device. For example, SR-IOV implementation can allow the I/O device to present itself as multiple, independent virtual devices implementing one or more virtualized backend drivers. For example, the SR-IOV capability can allow the I/O device to implement multiple virtual functions, wherein each virtual function can emulate the functionality of a backend driver or by an interface compatible with a virtualized backend driver.

As such, the ever-increasing availability of SRIOV devices cannot be fully utilized, and device passthrough is prohibited when memory is encrypted. When a DMA operation occurs, there is no way to associate the operation other than with the slot of origin or destination. Current solutions involve additional I/O overhead, which increases variability due to involving additional mechanisms such as a QEMU hypervisor in each I/O operation. Being able to utilize SRIOV devices removes the hypervisor from the data path, thereby increasing the security to allow for confidential computing.

Embodiments of the present disclosure may overcome the above and other problems by providing mechanisms for confidential computing on virtual machines by utilizing an I/O device to secure input/output operations with a virtual machine. Upon initiation, a host secure processor can load an encryption key of the virtual machine, via a secure key exchange protocol, onto a I/O device. Once loaded the I/O device can perform encryption/decryption operations on the memory being accessed. All encrypted data coming into the I/O device can remain encrypted, and data leaving the I/O can be encrypted by the device prior to transmission.

More specifically, embodiments of the disclosure extend I/O devices to allow them to receive encryption keys for each virtual function assigned to a virtual machine. A secure processor can be configured to distribute a corresponding encryption key to the I/O device upon initiation of the virtual machine. The distribution can occur via a secure transaction such as a standard key exchange. The secure processor can generate a protected key pair upon boot up and advertise the key as part of the device configuration. The encryption key can be created and assigned to a virtual machine upon its creation to allow for the memory on the virtual machine to be encrypted. The secure channel between the secure processor and the I/O device can be used to transmit the encryption key to the I/O device that can be used by the virtual function assigned to the virtual machine. This process can repeat for each virtual function assigned to a virtual machine using encrypted memory on the host.

Whenever a PCI transaction occurs, virtual function information is presented as part of the transaction. In particular, a bus transaction identifies a bus device function (BDF) and the virtual memory address. Embodiments expand the virtual functions of an I/O device to handle the encryption and decryption of communication between an assigned virtual machine. The translation subsystem within a virtual function can utilize an encryption key assigned to the corresponding virtual machine to perform encryption and decryption operations. Whenever a transaction occurs, using the BDF and virtual address, the memory controller returns the corresponding memory. If the virtual machine has encrypted the data, that data can be decrypted by the virtual function on the I/O device. When data is returned to the virtual machine, that data can be encrypted by the virtual function on the I/O device as well.

In some embodiments, memory addresses are adjusted whenever a value exists in both a virtual machine memory address and a DMA memory address. Upon startup, a device driver can write the receiving ring buffer for the DMA memory address space in the virtual function configuration space. During operations, the device driver can allocate received packets (e.g., I/O transactions) and write their DMA memory addresses into the receiving ring buffer. The device driver can also update the header and tail indices to the virtual function's allocation configuration space. The I/O device can retrieve the header and the DMA memory address of the packet and can encrypt incoming network data into a transmission buffer and request a DMA operation that has the DMA memory address.

During typical operation, a device driver can add data to the virtual machine memory and references the data into a receiving ring buffer identified by a DMA memory address. When adding to memory, the memory controller can encrypt the data that is being written using an encryption key associated with the virtual machine. The device driver can instruct the I/O device on how to access the data by either directly or indirectly specifying the DMA memory address of the data in the virtual machine memory address space. When an I/O transaction occurs, via the I/O device, such as a read request, the I/O transaction containing the BDF identifier and DMA memory address of the data in memory being requested is sent to the IOMMU. At that point, the IOMMU can translate the DMA memory address into the virtual machine memory address and fetch the encrypted data stored at that location. The encrypted data can then be transmitted to the I/O device that made the request. the I/O device can decrypt the data using the encryption key it received when the virtual machine was created.

In some embodiments, the I/O device and IOMMU utilize address translation services (ATS) to perform translations of DMA memory addresses to physical memory addresses. A combined memory controller and host bridge uses a translation agent to convert the I/O addresses via translation control entries (TCEs) in a TCE table (also known as an address translation and protection table). Some of the I/O device adaptors have address translation caches for local storage of TCEs.

In some embodiments, an encryption tweak function is applied to data being encrypted and stored in physical memory. Tweak functions can combine the physical memory address of data with a plaintext input parameter. The output of the tweak function can be encrypted using an advanced encryption standard (AES) encryption algorithm again to generate the ciphertext. For each reference (i.e., pointer) resulting in access to a physical memory page, the device driver can communicate a matching tweak function input parameter to the I/O device. By doing so, the I/O device can also apply the tweak function when performing write operations. In some embodiments, the virtual machine absolute address is used as the plain text input parameter, as it is visible to the virtual machine and used during setup of the IOMMU.

Architectures, such as Advanced Micro Devices (AMD) Secure Encrypted Virtualization (SEV), can utilize the physical memory address to perform tweak functions. In order to accommodate such architectures, the I/O device can utilize ATS to simultaneously obtain the physical memory address in order to also apply the tweak function that the architecture is applying to encrypt the data. In some embodiments, the physical memory address is requested simultaneously with the DMA request. Once the encrypted data is received by the I/O device, the tweak function can be applied prior to decryption. For DMA write operations, the I/O device must serialize the data.

In some embodiments, the I/O device utilizes the ATS to obtain the physical memory address of the data being requested. The ATS can provide the physical memory address and the lookup while the data is being fetched by the IOMMU. If no entry is found in the ATS, then the I/O device can utilize an ATS request to obtain the physical memory address as previously described.

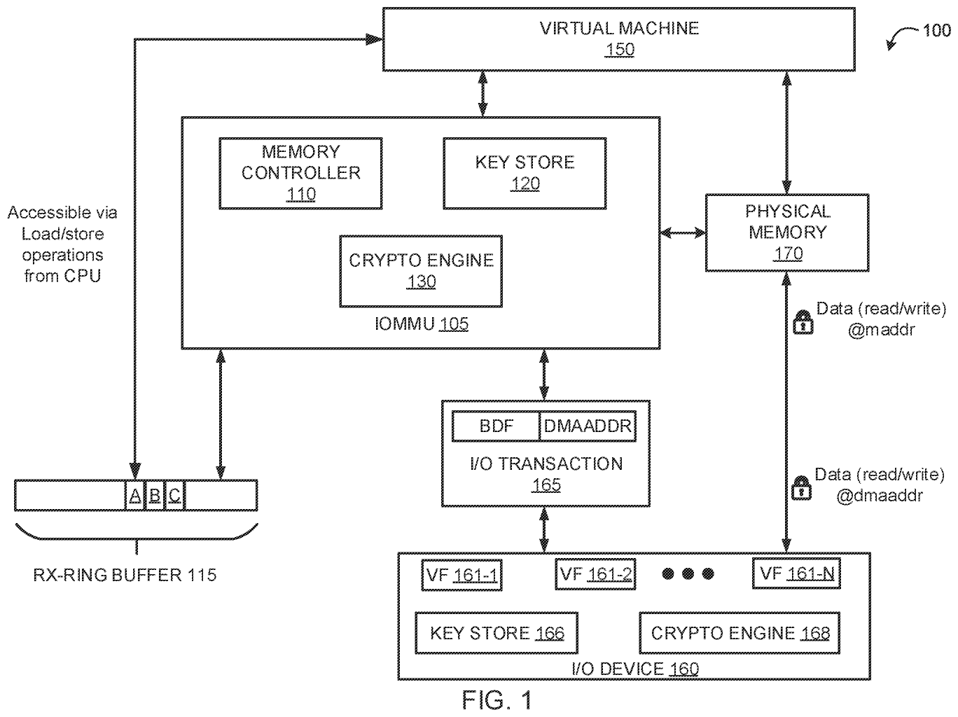

FIG. 1 is a block diagram illustrating a virtualization computing environment 100 for confidential computing on virtual machines by utilizing a device to secure input/output operations between the device and a virtual machine, in accordance with embodiments of the present disclosure. The virtualization computing environment 100 includes an IOMMU 105, a virtual machine 150, an I/O device, 160, and physical memory 170. The IOMMU 105 includes a memory controller 110, a key store 120, and a crypto engine 140. For purposes of the present description, it will be assumed that the illustrative embodiments are being implemented as part of a virtualization mechanism and specifically on a host computing system utilizing a hypervisor to spawn and operate virtual machines. However, this is only one possible implementation and is not intended to be limiting on the present disclosure. Other implementations in which virtual machines and/or containers are utilized may also be used without departing from the spirit and scope of the present disclosure.

The IOMMU 105 is a component of the virtualization computing environment 100 configured to translate device-visible virtual addresses to physical addresses and to connect the I/O device 160 to a DMA bus with the virtual machine 150. The IOMMU 105 can provide functionalities such as DMA remapping functionality that manipulates address translations for the I/O device 160 and interrupt remapping functionality that route interrupts of the I/O device 160 to the corresponding virtual machine 150. The IOMMU 105 includes a memory controller 110, a key store 120, and a crypto engine 130. The IOMMU 105, and the additional components, operate as a translation mechanism that translates I/O transactions 165 that can include a BFD and a DMA memory address into a physical memory address.

The IOMMU 105 includes a memory controller 110 configured to manage the flow of data going to and from the physical memory 170 of a computer. The memory controller 110 can be a separate chip or integrated into another chip, such as being placed on the same die or as part of a microprocessor. The memory controller 110 contains the logic necessary to read and write dynamic random-access memory (DRAM) located on the physical memory 170. In addition, the memory controller 110 has access to device driver data structures receiving ring buffer 115 and transmitting ring buffer (not shown). Both the receiving ring buffer 115, and the transmitting ring buffer, are relative to the virtual machine 150 and are encrypted by the virtual machine 150. Data is encrypted as it enters the receiving ring buffer 115, and when accessed by the I/O device 160, must be decrypted by the I/O device 160.

The receiving ring buffer 115 includes a header and tail index, including buckets A, B, and C. Each bucket can point to a memory buffer to which the I/O device 160 can perform DMA operations. Each bucket A, B, C, etc., can include store packets that have a value in a physical memory address and a DMA memory address. All memory accesses performed by the virtual machine 150 utilize the physical memory address. The I/O device 160 utilizes the DMA memory address where the IOMMU 105 provides translation functions between DMA memory addresses and physical memory addresses. The header and tail indices indicate which buffers are available can allow for DMA write operations. The transmission ring buffer also includes a similar structure as the receiving ring buffer 115, with the header and tail indices indicating which buffers are available for DMA read operations. The ring buffers 115 can be located in the virtual machine 150 encrypted memory. It should be noted that this approach can be applied in other settings. For example, encrypted containers protected by separate encryption keys and associated with an SR-IOV virtual function. Subsequent descriptions describe the approach using a guest virtual machine configuration, however, embodiments are not limited to such configuration

At startup, the device driver can write the receiving ring buffer 115 DMA memory address to the virtual functions 161 configuration space per each virtual function 161. During operations, the device driver running inside the virtual machine 150, can allocate receiving packet buffers and write their DMA memory addresses into the receiving ring buffer 115. The header and tail indices in the virtual functions 151 configuration space can be updated each time a receiving packet buffer is allocated. When the I/O device 160 grabs a packet of the header with the DMA memory address, it can first decrypt the DMA memory address, and then encrypt the incoming network data into the transmission ring buffer and also request a DMA operation of the encrypted memory with the decrypted DMA memory address. The DMA request can utilize the IOMMU 105 and does not interact with the key store 120. The memory controller 110 can be used to read and write directly to/from physical memory 170.

The key store 120 is a component of the IOMMU 105 configured to store sensitive data, such as passwords, cryptographic keys, cryptographic certificates, and other types of sensitive data. In some embodiments, the key store 120 can be a sandboxed or private area of a data store (not shown) in the IOMMU 105. The key store 120 can be reserved by the host for use only by the IOMMU 105. In addition to storing cryptographic keys generated for the virtual machine 150, the key store 120 can also store other keys (e.g., public keys) generated by other applications or other virtual machines in operation by the host.

The crypto engine 130 is a component of the IOMMU 105 configured as a cryptographic engine capable of conducting at least one cryptographic operation. The crypto engine can be part of a hardware unit like a controller, or it can be a hardware unit on its own, to supply cryptographic information. The cryptographic information includes, but is not limited to, encryption and decryption of I/O transmission between the virtual machine 150 and the I/O device 160.

The crypto engine 130 can utilize the encryption key stored within the key store 120 to perform encryption/decryption operations on the I/O transmissions between the virtual machine 150 and the I/O device. Any encryption/decryption mechanism can be used to store data in a way where data is provided to memory and cannot be interpreted without a proper encryption/decryption of the data after retrieval from memory.

The I/O device 160 is a component of the virtualization computing environment 100 that provides various functionalities to the virtual machine 150. For example, the I/O device 160 can be a network interface card (NIC), sound cards, keyboards, mice, hard drives, flash drives, sound cards, other peripheral component interconnect (PCI) devices, and the like. In some embodiments, the I/O device 160 provides SR-IOV virtualization, which makes the I/O device 160 appear as multiple virtual devices. The physical I/O device 160 can be referred to as a physical function, while the virtual devices can be referred to as virtual functions 161.

As shown, the I/O device 160 includes virtual function 161-1, 161-2, 161-N (collectively “virtual functions 161”) where N is a variable integer representing any number of possible virtual functions 161 and in accordance with embodiments of the present disclosure. Each of the virtual functions 161 includes a PCI configuration space accessible by its own BDF (e.g., routing ID). Additionally, each virtual function 161 can have its own memory space, which can be used to map its register set. The device driver can operate on the register set to allow it to be functional and appear as an independent I/O device 160.

The I/O device 160 also includes a key store 167 and a crypto engine 168. The key store 167 is a component of the I/O device 160 configured to store sensitive data, such as passwords, cryptographic keys, cryptographic certificates, and other types of sensitive data. In some embodiments, the key store 167 can be a sandboxed or private area of a data store (not shown) in the I/O device 160. In addition to storing cryptographic keys generated for the virtual machine 150, the key store 167 can also store other keys (e.g., public keys) generated by other applications or other virtual machines in operation by the host. The key store 167 can also limit access to cryptographic information that is assigned to a specific virtual function 161. For example, the virtual function 161-1 can be assigned to the virtual machine 150. As such, the only cryptographic information the virtual function 161-1 has access to in the key store 167 is cryptographic information (e.g., encryption key) relating to the virtual machine 150. The virtual function 161-1 will not have access to other cryptographic information relating to other virtual machines it is not assigned to.

The crypto engine 168 is a component of the I/O device 160 configured as a cryptographic engine capable of conducting at least one cryptographic operation. The crypto engine 168 can be part of a hardware unit like a controller, or it can be a hardware unit on its own, to supply cryptographic information. The cryptographic information includes, but is not limited to, encryption and decryption of I/O transmission between the virtual machine 150 and the virtual functions 161.

The crypto engine 168 can utilize the encryption key stored within the key store 167 to perform encryption/decryption operations on the I/O transmissions between the virtual machine 150 and the virtual functions 161. Any encryption/decryption mechanism can be used to store data in a way where data is provided to memory and cannot be interpreted without a proper encryption/decryption of the data after retrieval from memory.

When performing an I/O operation, the I/O device 160 transmits an I/O transaction 165 with virtual function information included within the transaction 165. In particular, the I/O transaction 165 includes the virtual function information, a BDF, and a DMA memory address location of the data being requested. Embodiments expand the virtual functions of the I/O device 165 to handle the encryption and decryption of the data being requested. The translation subsystem within a virtual function 161 can utilize an encryption key assigned to the corresponding virtual machine 150 to perform encryption and decryption operations. Whenever a transaction occurs, using the BDF and virtual address, the memory controller 110 returns the corresponding data. If the virtual machine 150 has encrypted the data, that data can be decrypted by the virtual function 161 on the I/O device 160. When data is returned to the physical memory 170, that data can be encrypted by virtual function 161 on the I/O device 160, as well.

In some embodiments, memory addresses are adjusted whenever a value exists in both a physical memory address and a DMA memory address. For example, upon startup, a device driver can write the receiving ring buffer 115 for the DMA memory address space in the virtual function 161 configuration space. During operations, the device driver can allocate received packets (e.g., I/O transaction 165) and write their DMA memory addresses into the receiving ring buffer 115. The device driver can also update the header and tail indices to the virtual function's 161 allocation configuration space. The I/O device 160 can retrieve the header and the DMA memory address of the packet. Since such addresses are encrypted, they first need to be decrypted on the device. The I/O device 160 can then encrypt incoming network data into a transmission buffer and request a DMA operation that has the DMA memory address.

During typical operation, a device driver can add data to the virtual machine memory and references the data into a receiving ring buffer identified by a DMA memory address. When adding to memory, the memory controller can encrypt the data that is being written using an encryption key associated with the virtual machine. The device driver can instruct the I/O device on how to access the data by either directly or indirectly specifying the DMA memory address of the data in the virtual machine memory address space. When an I/O transaction occurs, via the I/O device, such as a read request, the I/O transaction containing the BDF identifier and DMA memory address of the data in memory being requested is sent to the IOMMU. At that point, the IOMMU can translate the DMA memory address into the physical machine memory address and fetch the encrypted data stored at that location. The encrypted data can then be transmitted to the I/O device that made the request. The I/O device can decrypt the data using the encryption key it received when the virtual machine was created.

In some embodiments, the I/O device 160 and IOMMU utilize ATS to perform translations of the DMA memory addresses to physical memory addresses. A combined memory controller 110 and host bridge uses a translation agent to convert the I/O addresses via translation control entries (TCEs) in a TCE table (also known as an address translation and protection table).

In some embodiments, an encryption tweak function is applied to data being encrypted and stored in physical memory. Tweak functions can combine the physical memory address of data with input plaintext. The output of the tweak function can be encrypted using an AES algorithm again to generate the ciphertext. For each reference (i.e., pointer) resulting in access to a physical memory page, the device driver can communicate a matching tweak function input parameter to the I/O device 168. By doing so, the I/O device 160 can also apply the tweak function when performing write operations. In some embodiments, the virtual machine 150 absolute address is used as the plain text input parameter, as it is visible to the virtual machine and used during the setup of the IOMMU 105.

Thus, the illustrative embodiments provide mechanisms for confidential computing on virtual machines by securing input/output operations between a virtual machine and a device by performing encryption/decryption operations within the device. Embodiments extend traditional I/O devices by providing their virtual functions with encryption keys associated with virtual machines. When memory traffic is initiated from an I/O device (e.g., an SRIOV device), the IOMMU 105 can transmit encrypted data directly to the I/O device 160 without the need for the host to access the information or the IOMMU 105 to decrypt the data. Moreover, the mechanisms of the illustrative embodiments may operate in conjunction with hypervisor systems and/or other virtualization computing systems to perform confidential computing between I/O devices performing direct memory accesses to virtual machines.

It is noted that FIG. 1 is intended to depict the major representative components of a virtualization computing environment 100. In some embodiments, however, individual components may have greater or lesser complexity than as represented in FIG. 1, components other than or in addition to those shown in FIG. 1 may be present, and the number, type, and configuration of such components may vary.

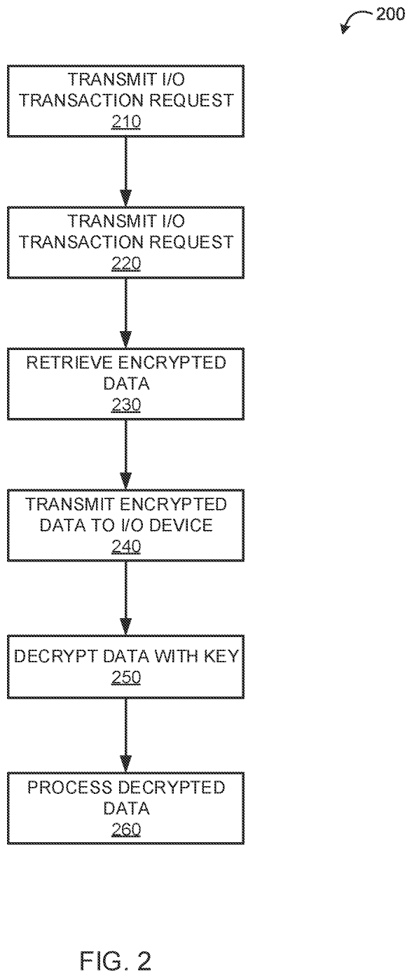

FIG. 2 is a flow diagram illustrating a process 200 of providing confidential computing on virtual machines by performing encryption/decryption operations between a virtual machine 150 and an I/O device 160 on the I/O device 160, in accordance with embodiments of the present disclosure. As shown in FIG. 2, the process 200 begins by establishing an I/O device 160 with an encryption key associated with a virtual machine 150. This is illustrated at step 210. A secure processor can be configured to generate and assign a corresponding encryption key to the I/O device 160 upon initiation of the virtual machine 150. The distribution can occur via a secure connection such as a standard key exchange. The secure processor can generate a protected key pair upon boot up and advertise the key as part of the device configuration. The encryption key can be created and assigned to a virtual machine 150 upon its creation to allow for the memory on the virtual machine 150 to be encrypted. The secure channel between the secure processor and the I/O device 160 can be used to transmit the encryption key to the I/O device 160 that can be used by the virtual function 161 assigned to the virtual machine 150. Once transmitted, the I/O device 160 can store the encryption key in a key store 167.

The I/O device transmits an I/O transaction 165 requesting encrypted data stored in a physical memory 170 by the virtual machine 150. This is illustrated at step 220. The I/O transaction 165 can include virtual function information, a bus device function, or BDF, and the DMA memory address location of the encrypted data being requested. The I/O transaction information can be transmitted to the memory controller 110 that can translate the BDF and the DMA memory address into a physical memory address using the IOMMU 105 that points to the encrypted data stored in physical memory 170. Once located, a DMA engine (not shown) can retrieve 230 the encrypted data and transmit 240 the encrypted data to the I/O device 160.

Once received by the I/O device, the crypto engine 168 stored within the I/O device 160 can apply the encryption key associated with the virtual machine to decrypt the encrypted data. This is illustrated at step 250. In some embodiments, a tweak function is applied to the encrypted data in order to decrypt the data. The tweak function can combine the physical memory address of data with a plaintext input parameter. The output of the tweak function can be encrypted using an AES encryption algorithm again to generate the plaintext of the data.

Once decrypted, the I/O device 160 processes the decrypted data. This is illustrated at step 260. During processing, the I/O device 160 can encrypt, during write operations, the processed data using the encryption key for I/O transmissions back to physical memory. The encrypted processed data can then be stored in physical memory 170. In some embodiments, the I/O device 160 applies a tweak function to the processed data prior to encryption.

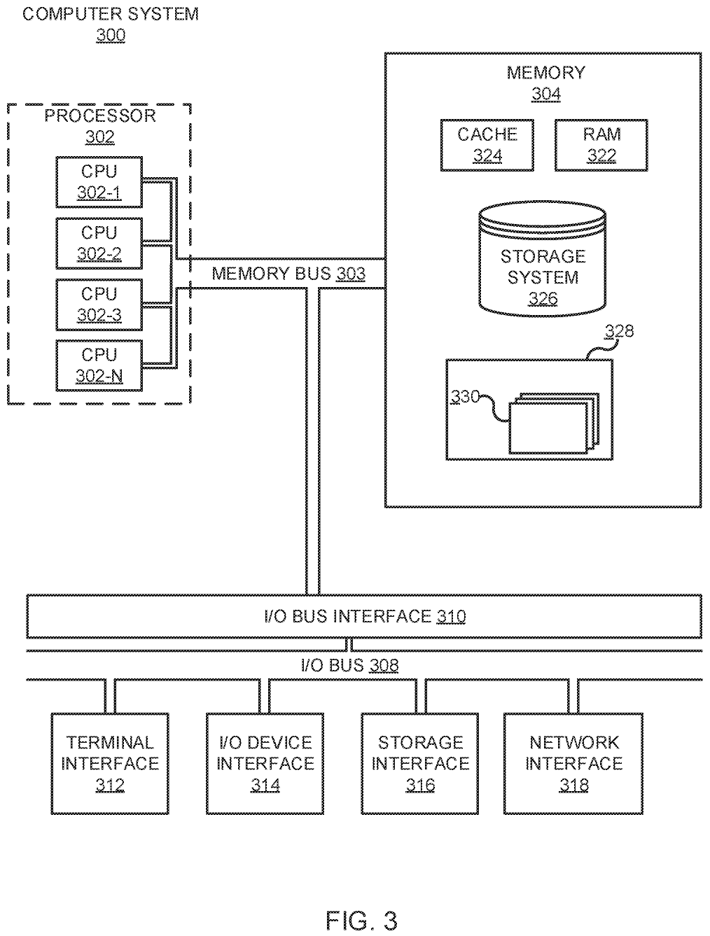

Referring now to FIG. 3, shown is a high-level block diagram of an example computer system 300 (e.g., the virtualization computing environment 100) that may be used in implementing one or more of the methods, tools, and modules, and any related functions, described herein (e.g., using one or more processor circuits or computer processors of the computer), in accordance with embodiments of the present disclosure. In some embodiments, the major components of the computer system 300 may comprise one or more processors 302, a memory 304, a terminal interface 312, an I/O (Input/Output) device interface 314, a storage interface 316, and a network interface 318, all of which may be communicatively coupled, directly or indirectly, for inter-component communication via a memory bus 303, an I/O bus 308, and an I/O bus interface 310.

The computer system 300 may contain one or more general-purpose programmable central processing units (CPUs) 302-1, 302-2, 302-3, and 302-N, herein generically referred to as the processor 302. In some embodiments, the computer system 300 may contain multiple processors typical of a relatively large system; however, in other embodiments, the computer system 300 may alternatively be a single CPU system. Each processor 302 may execute instructions stored in the memory 304 and may include one or more levels of onboard cache.

The memory 304 may include computer system readable media in the form of volatile memory, such as random-access memory (RAM) 322 or cache memory 324. Computer system 300 may further include other removable/non-removable, volatile/non-volatile computer system storage media. By way of example only, storage system 326 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, the memory 304 can include flash memory, e.g., a flash memory stick drive or a flash drive. Memory devices can be connected to memory bus 303 by one or more data media interfaces. The memory 304 may include at least one program product having a set (e.g., at least one) of program modules that are configured to carry out the functions of various embodiments.

Although the memory bus 303 is shown in FIG. 3 as a single bus structure providing a direct communication path among the processors 302, the memory 304, and the I/O bus interface 310, the memory bus 303 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 310 and the I/O bus 308 are shown as single respective units, the computer system 300 may, in some embodiments, contain multiple I/O bus interface units, multiple I/O buses, or both. Further, while multiple I/O interface units are shown, which separate the I/O bus 308 from various communications paths running to the various I/O devices, in other embodiments, some or all of the I/O devices may be connected directly to one or more system I/O buses.

In some embodiments, the computer system 300 may be a multi-user mainframe computer system, a single-user system, or a server computer or similar device that has little or no direct user interface but receives requests from other computer systems (clients). Further, in some embodiments, the computer system 300 may be implemented as a desktop computer, portable computer, laptop or notebook computer, tablet computer, pocket computer, telephone, smartphone, network switches or routers, or any other appropriate type of electronic device.

It is noted that FIG. 3 is intended to depict the major representative components of an exemplary computer system 300. In some embodiments, however, individual components may have greater or lesser complexity than as represented in FIG. 3, components other than or in addition to those shown in FIG. 3 may be present, and the number, type, and configuration of such components may vary.

One or more programs/utilities 328, each having at least one set of program modules 330 (e.g., the virtualization computing environment 100), may be stored in memory 304. The programs/utilities 328 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 328 and/or program modules 330 generally perform the functions or methodologies of various embodiments.

It is to be understood that although this disclosure includes a detailed description on cloud computing, implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-guest model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

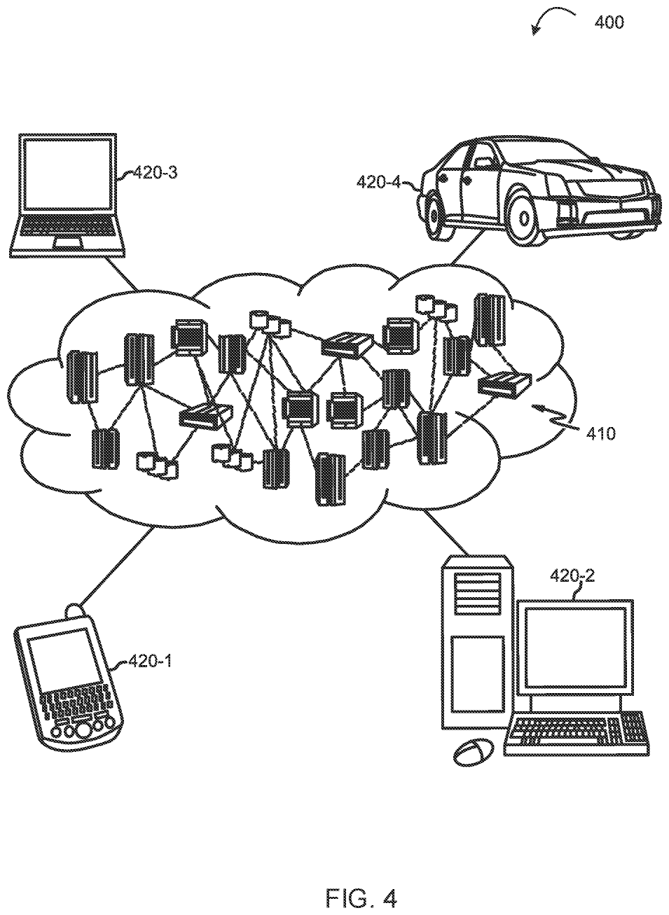

Referring now to FIG. 4, illustrative cloud computing environment 400 is depicted. As shown, cloud computing environment 400 includes one or more cloud computing nodes 410 with which local computing devices used by cloud consumers, such as, for example, personal digital assistant (P.D.A.) or cellular telephone 420-1, desktop computer 420-2, laptop computer 420-3, and/or automobile computer system 420-4 may communicate. Nodes 410 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 420-1 to 420-4 shown in FIG. 4 are intended to be illustrative only and that computing nodes 410 and cloud computing environment 400 can communicate with any type of computerized device over any type of network and/or network addressable connection (e.g., using a web browser).

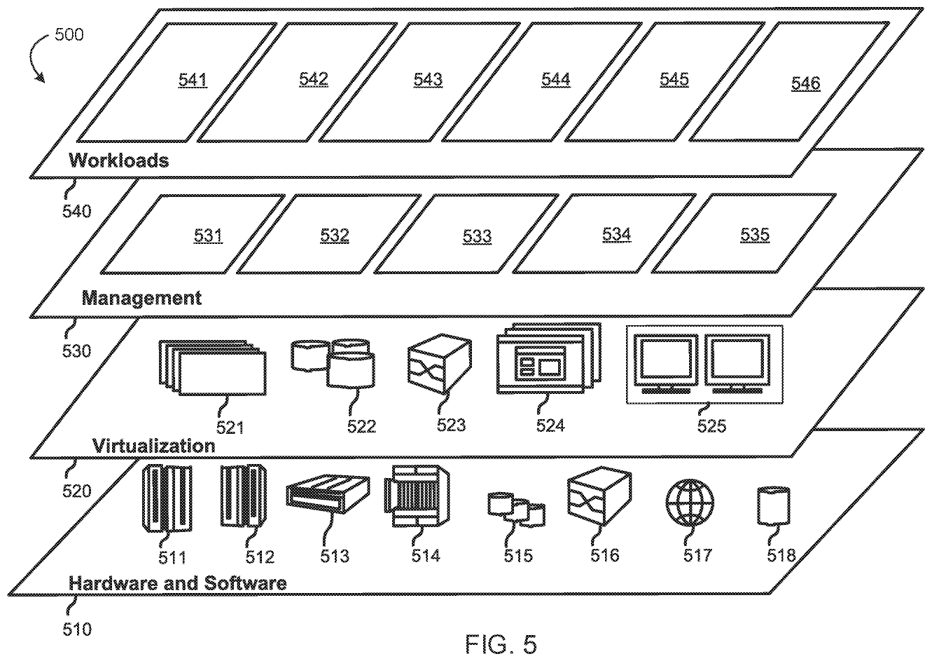

Referring now to FIG. 5, a set of functional abstraction layers 500 provided by cloud computing environment 400 (FIG. 4) is shown. It should be understood in advance that the components, layers, and functions shown in FIG. 5 are intended to be illustrative only and embodiments of the disclosure are not limited thereto. As depicted, the following layers and corresponding functions are provided:

Hardware and software layer 510 includes hardware and software components. Examples of hardware components include mainframes 511; RISC (Reduced Instruction Set Computer) architecture-based servers 512; servers 513; blade servers 514; storage devices 515; and networks and networking components 516. In some embodiments, software components include network application server software 517 and database software 518.

Virtualization layer 520 provides an abstraction layer from which the following examples of virtual entities may be provided: virtual servers 521; virtual storage 522; virtual networks 523, including virtual private networks; virtual applications and operating systems 524; and virtual clients 525.

In one example, management layer 530 may provide the functions described below. Resource provisioning 531 provides dynamic procurement of computing resources and other resources that are utilized to perform tasks within the cloud computing environment. Metering and Pricing 532 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 533 provides access to the cloud computing environment for consumers and system administrators. Service level management 534 provides cloud computing resource allocation and management such that required service levels are met. Service Level Agreement (SLA) planning and fulfillment 535 provide pre-arrangement for, and procurement of, cloud computing resources for which a future requirement is anticipated in accordance with an SLA.

Workloads layer 540 provides examples of functionality for which the cloud computing environment may be utilized. Examples of workloads and functions which may be provided from this layer include mapping and navigation 541; software development and lifecycle management 542; virtual classroom education delivery 543; data analytics processing 544; transaction processing 545, and a virtualization computing environment 546.

The present disclosure may be a system, a method, and/or a computer program product at any possible technical detail level of integration. The computer program product may include a computer-readable storage medium (or media) having computer readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But the various embodiments may be practiced without these specific details. In other instances, well-known circuits, structures, and techniques have not been shown in detail in order not to obscure embodiments.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

It should first be appreciated that throughout this description the term “mechanism” is used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illu strative examples, “at least one of” can be, for example, without limitation, two of item A; one of item B; and ten of item C; four of item B and seven of item C; or other suitable combinations.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
establishing an input/output (I/O) device with an encryption key associated with a virtual machine;
transmitting, by the I/O device, an I/O transaction requesting encrypted data stored in physical memory by the virtual machine, wherein the I/O transaction includes a direct memory access (DMA) memory address and a bus device function;
retrieving, by an input/output memory management unit (IOMMU), the encrypted data that is mapped from the DMA memory address to a physical memory address in the physical memory;
transmitting, by the IOMMU, the encrypted data to the I/O device;
decrypting, by the I/O device, the encrypted data using the encryption key associated with the virtual machine; and
processing, by the I/O device, the decrypted data.

2. The method of claim 1, wherein establishing the I/O device comprises:
establishing a secure connection between a secure processor and the I/O device;
generating, by the secure processor, the encryption key associated with the virtual machine;
assigning, by the secure processor, the encryption key to the virtual machine upon creation of the virtual machine;
transmitting the encryption key to the I/O device; and
storing the encryption key in a key store on the I/O device.

3. The method of claim 1, wherein processing the decrypted data comprises:
encrypting, during a write operation, the processed data using the encryption key for I/O transmission back to the physical memory; and
storing the encrypted processed data in the physical memory.

4. The method of claim 1, wherein a tweak function is applied to the encrypted data prior to storage in the physical memory.

5. The method of claim 4, wherein the I/O device utilizes address translation services to perform translations of the DMA memory address to a physical memory address of the encrypted data.

6. The method of claim 5, wherein an absolute address of the virtual machine is used as a plaintext input parameter for the tweak function.

7. The method of claim 1, wherein I/O device includes a key store for storing encryption keys associated with virtual machines and a crypto engine for performing cryptographic functions with the encryption keys.

8. The method of claim 1, wherein the I/O device is a single-root I/O virtualization (SRIOV) device capable of direct memory access I/O transactions with the virtual machine.

9. The method of claim 1, wherein the virtual machine is a container in a cloud computing environment.

10. A computer program product comprising a computer readable storage medium having a computer readable program stored therein, wherein the computer readable program, when executed on a computing device, causes the computing device to:
establish an input/output (I/O) device with an encryption key associated with a virtual machine;
transmit, by the I/O device, an I/O transaction requesting encrypted data stored in physical memory by the virtual machine, wherein the I/O transaction includes a direct memory access (DMA) memory address and a bus device function;
retrieve, by an input/output memory management unit (IOMMU), the encrypted data that is mapped from the DMA memory address to a physical memory address in the physical memory;
transmit, by the IOMMU, the encrypted data to the I/O device;
decrypt, by the I/O device, the encrypted data using the encryption key associated with the virtual machine; and
process, by the I/O device, the decrypted data.

11. The computer program product of claim 10, wherein the instructions to establish the I/O device comprise instructions to:
establish a secure connection between a secure processor and the I/O device;
generate, by the secure processor, the encryption key associated with the virtual machine;
assign, by the secure processor, the encryption key to the virtual machine upon creation of the virtual machine;
transmit the encryption key to the I/O device; and
store the encryption key in a key store on the I/O device.

12. The computer program product of claim 10, wherein the instructions to process the decrypted data comprise instructions to:
encrypt, during a write operation, the processed data using the encryption key for I/O transmission back to the physical memory; and
store the encrypted processed data in the physical memory.

13. The computer program product of claim 10, wherein a tweak function is applied to the encrypted data prior to storage in the physical memory.

14. The computer program product of claim 13, wherein the I/O device utilizes address translation services to perform translations of the DMA memory address to a physical memory address of the encrypted data.

15. The computer program product of claim 14, wherein an absolute address of the virtual machine is used as a plaintext input parameter for the tweak function.

16. The computer program product of claim 10, wherein I/O device includes a key store for storing encryption keys associated with virtual machines and a crypto engine for performing cryptographic functions with the encryption keys.

17. The computer program product of claim 10, wherein the I/O device is a single-root I/O virtualization (SRIOV) device capable of direct memory access I/O transactions with the virtual machine.

18. An apparatus comprising:
a processor; and
a memory coupled to the processor, wherein the memory comprises instructions which, when executed by the processor, cause the processor to:
establish an input/output (I/O) device with an encryption key associated with a virtual machine;
transmit, by the I/O device, an I/O transaction requesting encrypted data stored in physical memory by the virtual machine, wherein the I/O transaction includes a direct memory access (DMA) memory address and a bus device function;
retrieve, by an input/output memory management unit (IOMMU), the encrypted data that is mapped from the DMA memory address to a physical memory address in the physical memory;
transmit, by the IOMMU, the encrypted data to the I/O device;
decrypt, by the I/O device, the encrypted data using the encryption key associated with the virtual machine; and
process, by the I/O device, the decrypted data.

19. The apparatus of claim 18, wherein the instructions to establish the I/O device comprise instructions that cause the processor to:
establish a secure connection between a secure processor and the I/O device;
generate, by the secure processor, the encryption key associated with the virtual machine;
assign, by the secure processor, the encryption key to the virtual machine upon creation of the virtual machine;
transmit the encryption key to the I/O device; and
store the encryption key in a key store on the I/O device.

20. The apparatus of claim 18, wherein the instructions to process the decrypted data comprise instructions that cause the processor to:
encrypt, during a write operation, the processed data using the encryption key for I/O transmission back to the physical memory; and
store the encrypted processed data in the physical memory.
